(19) United States
(12) Patent Application Publication
(10) Pub. No.: US 2016/0246260 A1
(43) Pub. Date: Aug. 25, 2016

(54) Diving Watch

(71) Applicant: ROLAND ITEN MECHANICAL LUXURY SA, Mont-sur-Lausanne (CH)

(72) Inventor: Roland Iten, Mont-sur-Lausanne (CH)

(21) Appl. No.: 15/026,257

(22) PCT Filed: Sep. 19, 2014
(86) PCT No.: PCT/IB2014/064660

§ 371 Date: Mar. 31, 2016

(30) Foreign Application Priority Data
Oct. 1, 2013 (CH) 01677/13

(51) Int. Cl. G04B 37/08

(52) U.S. Cl. CPC G04B 37/081

(57) ABSTRACT

A watch, for example a diving watch, with at least a watch case and a watch base, the watch being at least in an unsealed state and in a sealed state, wherein the change from one state to another is made by a movement of the case relatively to the base.

### REFERENCE TO CORRESPONDING APPLICATION

The present application claims priority to earlier Swiss patent application No 01677/13 filed on Oct. 1, 2013 in the name of ROLAND ITEM MECHANICAL LUXURY SA the content of this earlier application being incorporated by reference in its entirety in the present application.

### TECHNICAL FIELD

The present invention concerns a diving watch and similar devices.

### BACKGROUND ART

Diving watches are known per se in the art of watch making. Such watches must be able to withstand a certain underwater pressure and they usually have a unidirectionally rotatable ring that is able to mark certain moment of the dive (for example the start of the dive) so that the user may easily calculate his dive time.

Some watches, in addition to the classical crown, carry a valve that allows to regulate the pressure inside the watch thus avoiding any damage to the watch if the pressure difference between the inside of the watch and the outside of the watch is too high.

In order to provide a watertight position of the crown with respect to the watch case, numerous systems have been developed with O-rings and screwable crowns.

One example used by the company Panerai™ is illustrated in FIGS. 1 to 3B and detailed hereunder.

There is a watch case 1 with a crown 2, a base 3 mounted on the case, the base carrying a crown sealing lever 4 that is used to push the crown towards the case 1 and seal its position in the case 1. This diving watch further comprises a ring 5 which can be turned anticlockwise, a dial 6, watch pointers 7 (seconds, minutes and hours) and a watch strap 8.

FIG. 2 illustrates the unsealed position of the crown 2 with the lever 4 being pushed upwards.

This system allows an easy manipulation of the crown by comparison to watches on which the crown is screwed for reaching a sealed position.

FIGS. 3A and 3B illustrate one problem one is faced with when using a lever 4 for sealing the crown 2 in the case 1 by showing two different fingers 9 of a user. In FIG. 3A, the nail of the finger 9 is sufficiently short to allow an actuation of the lever 4, whereas in FIG. 3B, the nail is too long and the lever 4 cannot be reached and actuated properly.

One is also faced with other actuation problems when the crown 2 is sealed by screwing on the case 1. In this design, one may screw the crown “too much” and then it becomes very difficult to unscrew. In such an embodiment, the use of the crown 2 is also impaired and this can be problematic for the user if he fails to be able to unscrew the crown.

Finally, it is also difficult for a user to determine whether the crown has been sufficiently turned to ensure a proper sealing so that a user will tend to “force” the screwing of the crown to be sure.

### SUMMARY OF THE INVENTION

Accordingly, one aim of the present invention is to improve the known devices and systems.

More specifically, on aim of the present invention is to provide a system for sealing a crown that is easy to use and safe.

In one embodiment, the invention concerns watch, for example a diving watch, with at least a watch case and a watch base and a watch strap, wherein said watch may be placed at least in an unsealed state and in a sealed state, wherein the change from one state to another state is made by a movement of the case relatively to the base.

In one embodiment, the movement may be a rotation or the case with respect to the base.

In one embodiment, the case and the base are in the same plane in the sealed state and in the unsealed state.

In one embodiment, the case and the base are not in the same plane in the sealed state and in the unsealed state.

In one embodiment, the sealed state includes a closing of the watch case with at least one crown.

In one embodiment, the sealed state is a locked position of the case with respect to the base ensured by locking means.

In one embodiment, the watch comprises at least one protection unit to protect each crown.

In one embodiment, the crown(s) is (are) used to adjust an element of the watch. This may be a mechanical element or a digital element, for example appearing on a screen of the watch.

The present invention also concerns a watch comprising an hours pointer, a minutes pointer and a seconds pointer, and wherein the minutes pointer forms a bridge under which the seconds pointer passes, the seconds pointer have the shape of a snail, such as the seconds value to be read in indicated on the minutes pointer.

The pointer system of the invention may be applied to any type of watch, as the mechanism allowing to form a sealed state and an unsealed state.

### BRIEF DESCRIPTION OF THE DRAWINGS

FIGS. 1 to 3B illustrate a diving watch of the prior art;

FIGS. 4A to 4D illustrate the principle of the invention in a first embodiment;

FIGS. 5A to 5C illustrate schematically the different parts of the watch in a first embodiment;

FIGS. 6A to 6D illustrate schematically the watch according to an embodiment in different positions;

FIGS. 7A to 7C illustrate partially cut side views of the watch in different positions;

FIGS. 8A to 8C illustrate details of the locking of the crown 20 according to the present invention;

FIG. 9A to 9CD illustrates possible embodiments of locking means;

FIGS. 10A to 10C and 11A to 11D illustrate another embodiment of the present invention;

FIGS. 12A to 12C illustrate side views in partial cut of the second embodiment;

FIGS. 13A to 13E illustrate a particular embodiment of pointers to indicate time for example.

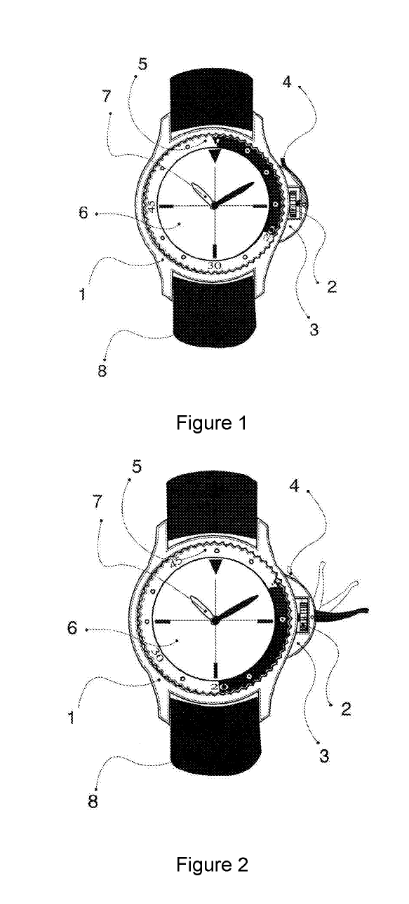

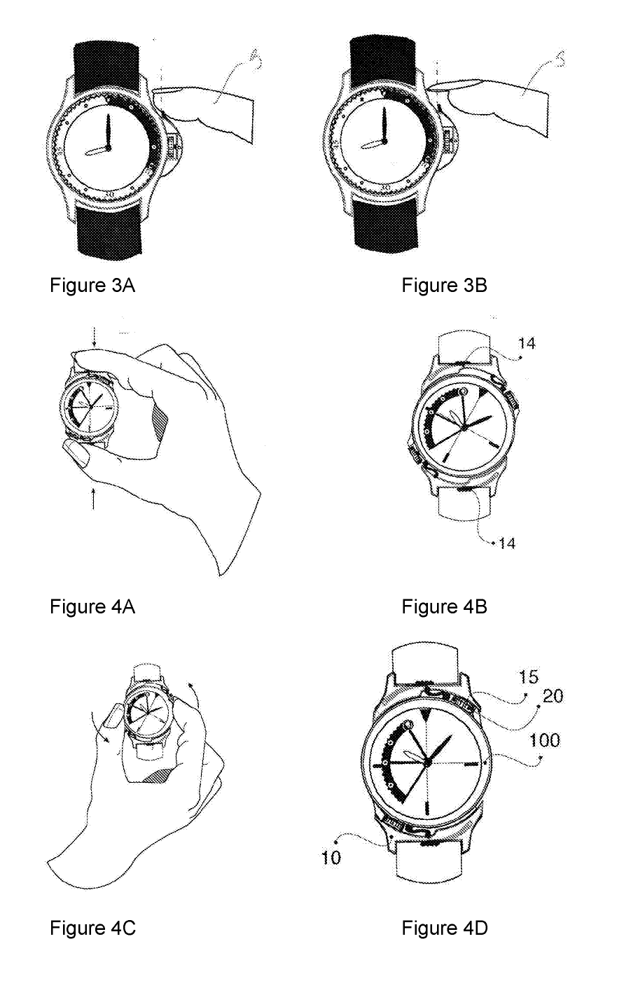

### DETAILED DESCRIPTION

The principle of the invention is illustrated in the figures corresponding to several embodiments of the present invention.

In the present description, the same elements will be identified by the same references for the sake of clarity and simplicity.

According to the invention, the watch case 100 is mounted in a watch case base 10 and allowed to rotate relatively to said base 10 via an axle 11. It is therefore possible to rotate the case in different positions as illustrated in FIGS. 4A to 4D and explained in more detail hereunder, some position of the case 1 being such that the crown 20 is sealed.

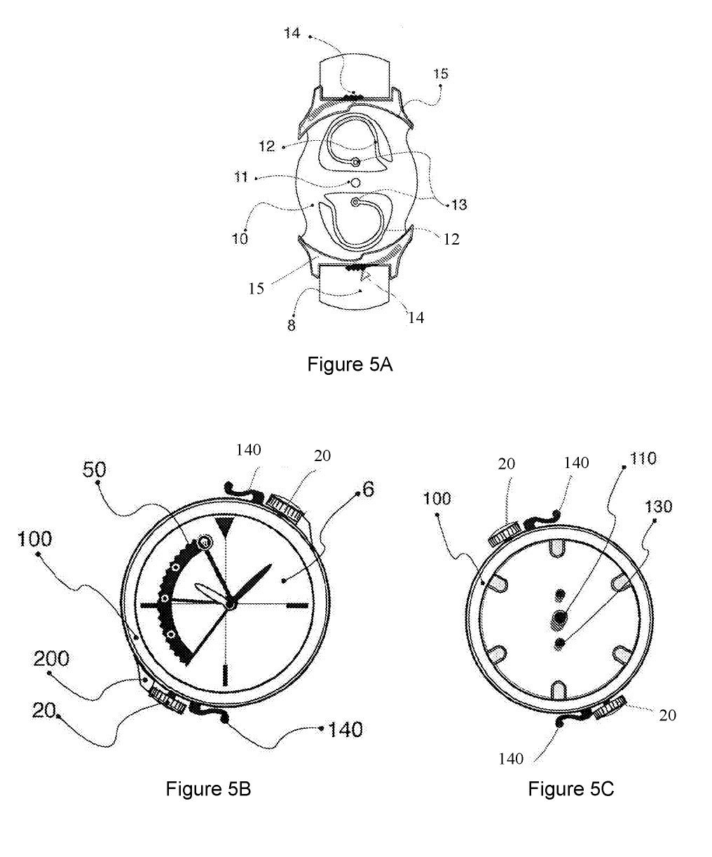

FIGS. 5A to 5C illustrate the different parts of a first embodiment of the invention. It comprises a watch case base 10 with a watch case base axle 11, two watch base springs 12 each with a spring connection 13, two opening levers 14 which are mounted on a sealing wall 15.

In FIG. 5B, one sees the watch case 100 from the front side and it carries (in this example) two crowns 20, a dial 6, a 20 minutes crown 50 that may be adjusted by one of the crowns 20, two locking spring units 140 and a crown deformation protection unit 200.

FIG. 5C illustrates the watch case 100 from the back with its axle 110 and holes 130 for connection of the case 100 to the spring connectors 13.

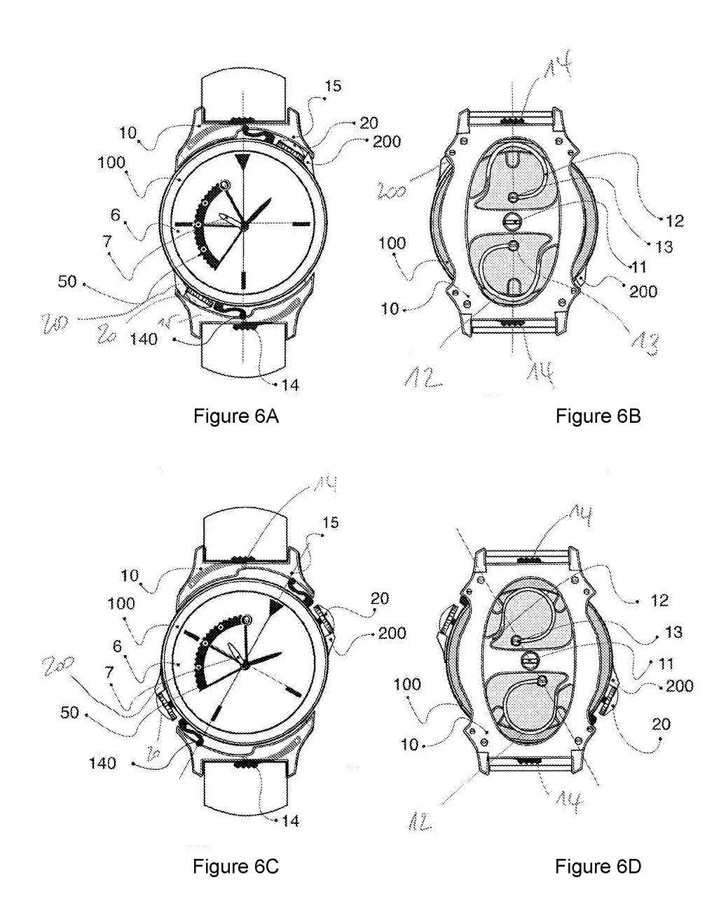

FIG. 6A illustrates a front view of the watch of a first embodiment in a sealed state, meaning the crowns 20 are pushed towards the case 100 by the rotation of the case 100 relatively to the base 10 around axle 11, the pushing effect being imparted by the walls 15. The inner side of the walls 15 (which act on the crowns 20) may have a small slope to progressively push the crowns 20 towards the case 100 and thereby reach the sealed position. The watch case 100 is in a locked (and sealed) position in FIGS. 6A/6B by virtue of the springs 140 cooperating with the walls 15. To unlock the case 100 and allow its rotation (for example as illustrated in FIGS. 6C/6D), the user pushes on opening levers 14 which pushing frees the case 100 and allows its rotation around axle 11 (compare FIGS. 6A and 6C).

FIG. 6B is a back view of FIG. 6A with the case 100 in sealed position showing the axle 11 and the spring 12 ends 13 connected to the case 100.

The wall 200 is used as a crown protection unit that prevents any side pressure or constraint being applied directly to the crown 20 itself and thus avoid a deformation of the crowns 20.

FIGS. 6C and 6D illustrate front and back views of the watch in a second position which is unsealed. The case 100 has been rotated clockwise of about 30° and the crowns 20 are now in an unsealed position. As explained above, the case may be allowed to rotate from the position of FIG. 6A by pushing the levers 14 that press on the springs 140.

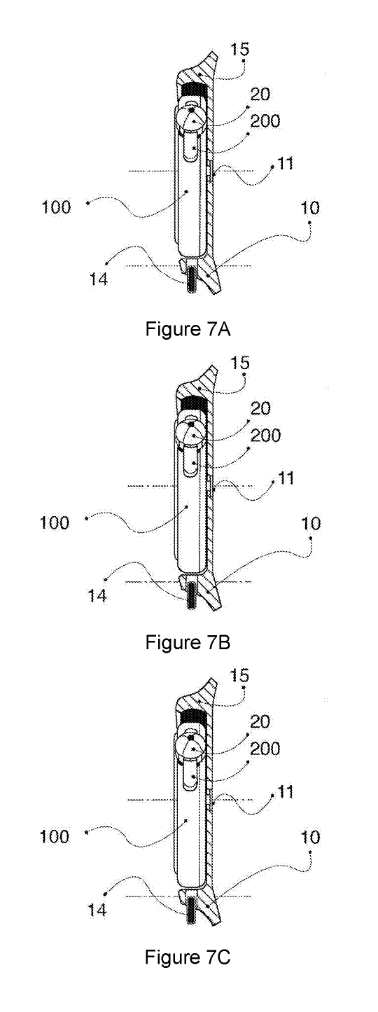

FIGS. 7A to 7C Illustrate partially cut side views of the watch in different positions; FIG. 7A in an unsealed position (such as in FIG. 6C), FIG. 7B still in an unsealed position (such as a position between FIGS. 6C and 6A) and FIG. 7C in a sealed position (such as in FIG. 6A)

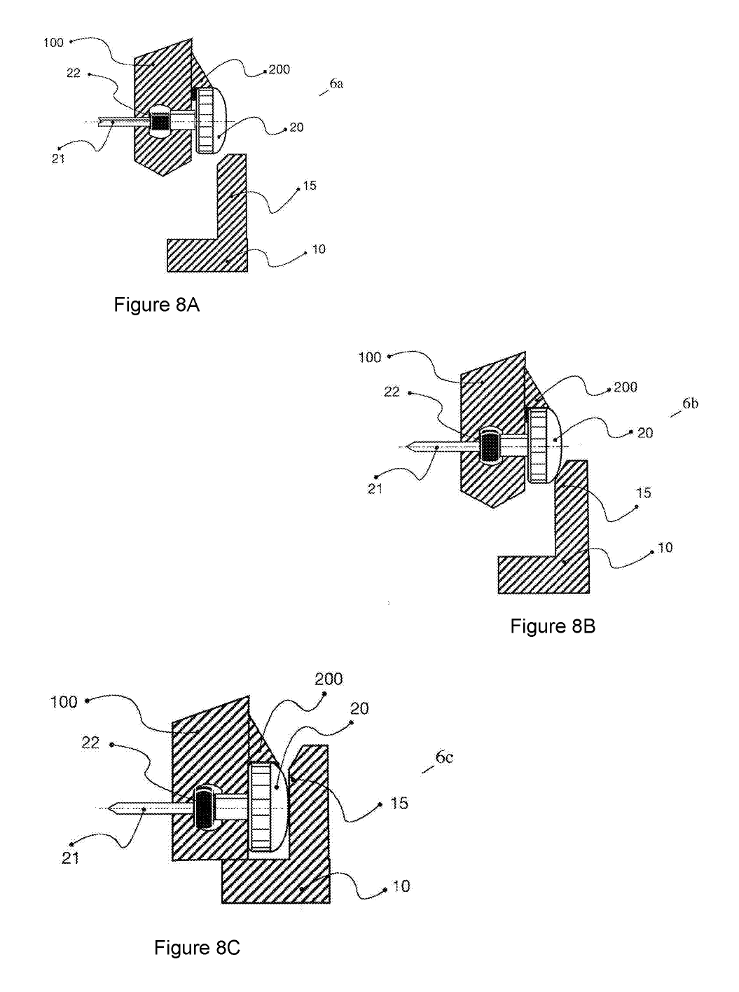

FIGS. 8A to 8C illustrate partial details of the locking of the crown 20 according to the present invention. As illustrated in FIGS. 8A-8C, by rotation of the case 100 relatively to the base 10, the crown 20 is pushed towards the case 100 by wall 15 such that the crown 20 has an axial movement relatively to the case 100, said movement allowing to compress a sealing means 22 for example an O-ring or any other equivalent means to lock the case and render it watertight. The final (sealed) position is illustrated in FIG. 8C and an unsealed position is illustrated in FIG. 8A.

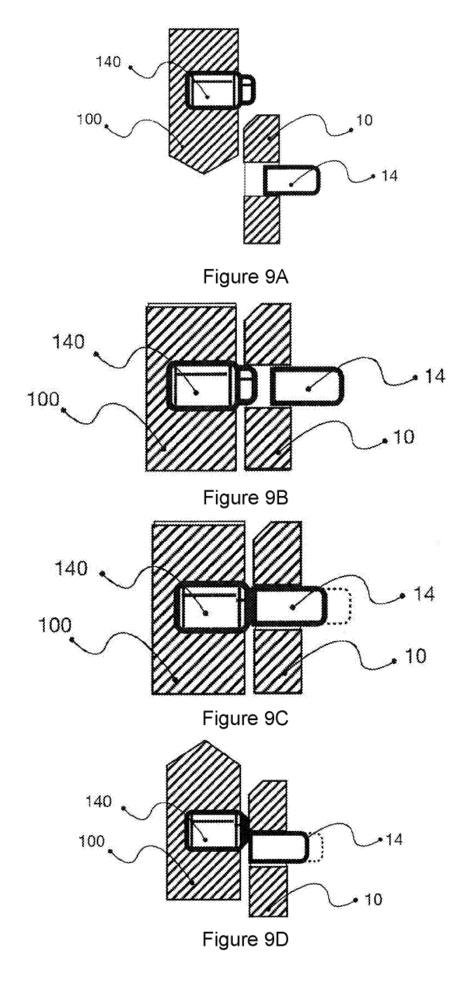

FIG. 9A to 9CD illustrates possible embodiments of locking means 14, 140 used to lock the case relatively to the base 10 in accordance with the principle of the present invention. Locking spring unit 140 may comprise a spring acting on a ball and to unlock the system, lever 14 pushes the ball against the spring and once the ball is sufficiently pushed backwards (FIG. 9C), the system is unlocked (FIG. 9D). This example allows an “automatic” locking (FIG. 9A-FIG. 9B) since the ball is pushed by a slope on wall of base 10, but only a “manual” unlocking (FIG. 9B-FIG. 9C-FIG. 9D) by an action (pushing) on lever 14.

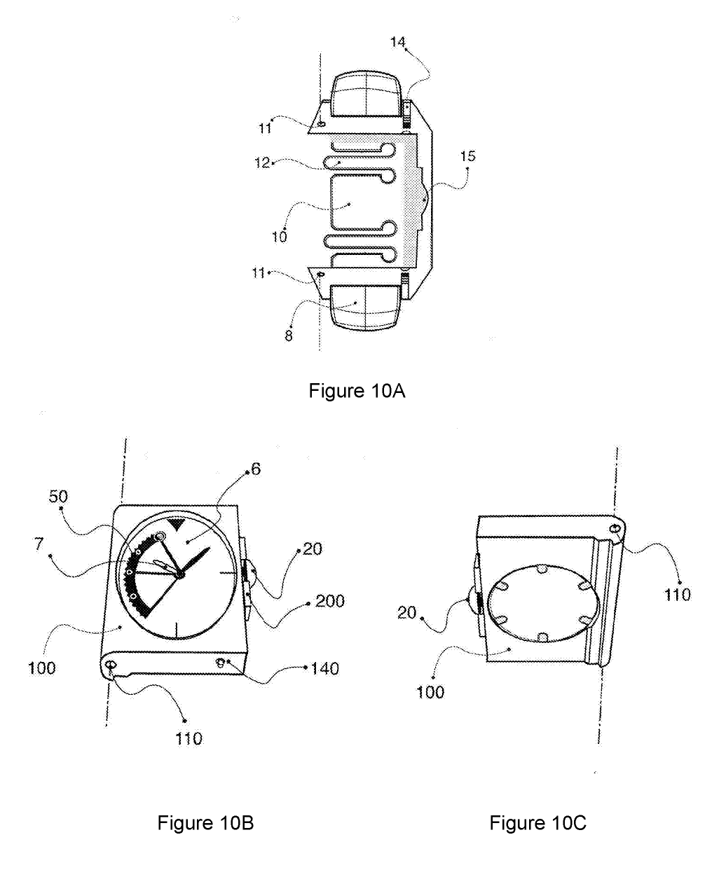

FIGS. 10A to 10C illustrate another embodiment of the present invention. Here, the idea is again the lock the crown 20 by a relative movement of the watch case 100 with respect to the watch base 10 but the relative motion is not the same axial rotation as in previous embodiments discussed above where the case 100 and base 10 remain in the same parallel planes.

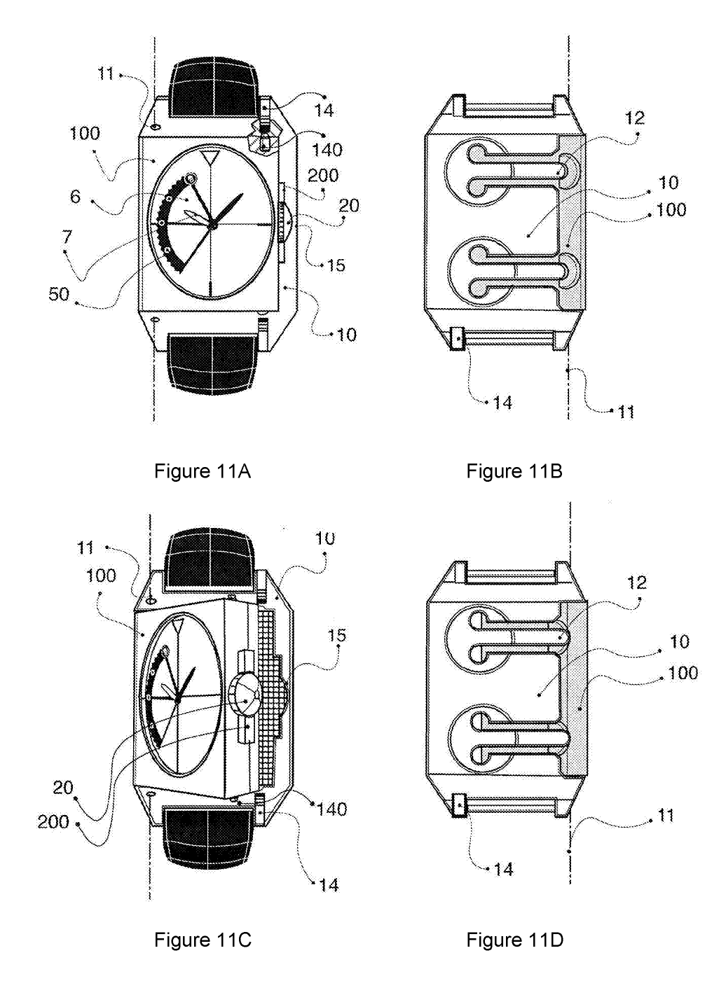

In this second embodiment, the rotation axis 110 is in the plane of the base such that the rotation of the case 100 moves one side of the case 100 away (or towards) the base 10. This is illustrated in more detail in FIGS. 11A and 11C, 11A illustrating the sealed position and 11C the unsealed position in which a side of the case 100 is rotated upward around axis 110.

FIGS. 11B and 11D illustrated the back side of this embodiment in the two positions.

The case 100 may be maintained in the sealed position of FIG. 11A by a locking mechanism as illustrated in FIGS. 9A to 9D (see references 14 and 140 in FIG. 11A). Of course, other equivalent means are possible.

As described herein, in the sealed position, the crown 20 is pushed towards the case 100 to carry out the sealing effect discussed above.

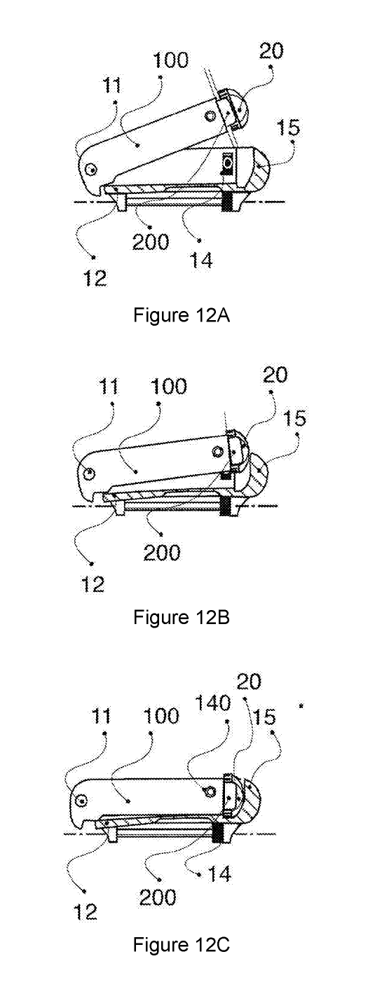

FIGS. 12A to 12C illustrate side views in partial cut of the second embodiment. In FIG. 12A, the case 100 is in an unsealed position (as in FIG. 11C), in FIG. 12B, the case 100 is pushed and rotates towards the base 10 (but not in the sealed position) and in FIG. 12C, the case 100 is in the sealed position (as in FIG. 11A). The rotation of the case 100 towards the base 10 acts on the spring 12 that is pushed downwards, i.e. loaded (compare FIG. 12A with 12B/12C), the spring 12 helping the watch case 100 to move back into the unsealed position of FIG. 11C.

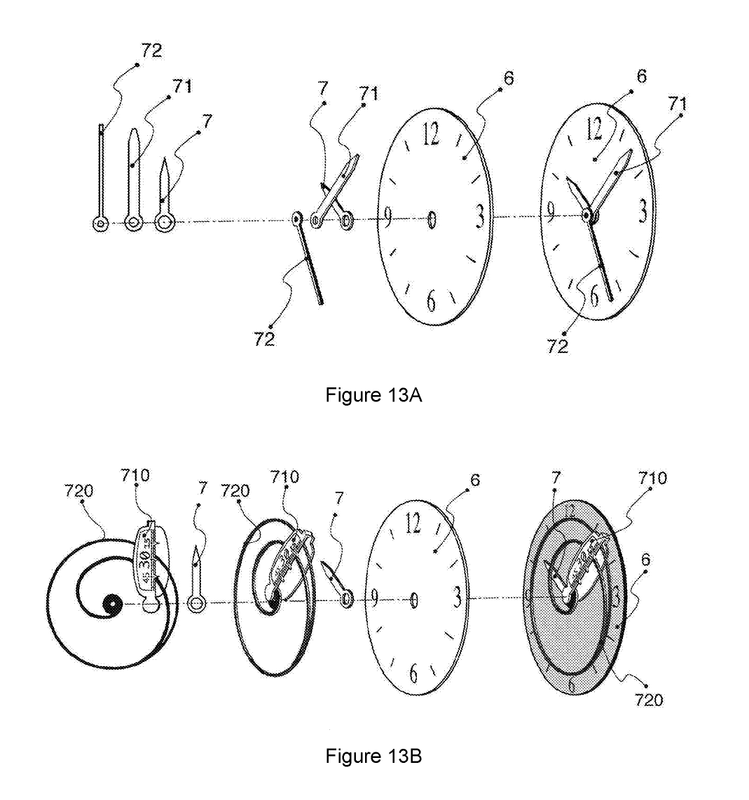

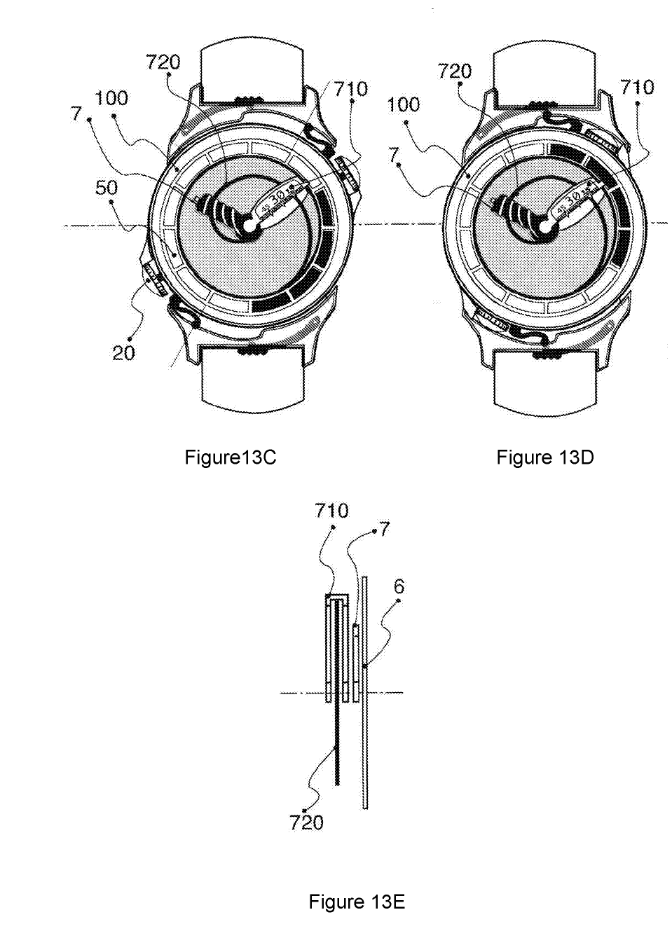

FIGS. 13A to 13E illustrate a particular embodiment of the pointers of the watch, this embodiment being applicable to all watches and embodiments described herein.

Specifically, FIG. 13A illustrate a known way of making a watch dial 6 with its pointers 7 (for the hours), 71 (for the minutes), 72 (for the seconds).

FIGS. 13B illustrates the different parts used to form the new indicators. If the hours pointer 7 does not change, the minutes pointer 710 comprises a part forming a bridge over the seconds pointer 720 that has a “snail” shape so that it may properly indicate the seconds with respect to the minutes pointer 710 bridge. This construction allows to keep the same order of pointers (a standard order: hours-minutes-seconds which allows the use of standard watch movements) but gives a really improved reading of the time. The user does not have to look for several pointers (three) to read time. Only two is sufficient here, the seconds being read on the minutes. This principle may also be applied to the hours pointer and minutes pointer to indicate time in the same manner.

The drawing on the right side of FIG. 13B illustrates the pointer system as described herein in a mounted state.

FIGS. 13C and 13D illustrate the pointer system as described herein in the watch of the first embodiment described above, in unsealed state (FIG. 13C) and sealed state (FIG. 13D).

FIG. 13E illustrates a side view of the pointer system described herein in assembled state.

The crowns 20 described herein may have several functions: adjustment of time or date, as in standard watches, other parameters as desired on the watch

For example, one crown 20 may be used for rotating a part in the watch, of a part of the dial (like date) but for another purpose (timing) which may be of interest for a user etc. For example, this system may be used to replace the ring of the watch. Other functions of the watch may be adjusted by the crowns as desired. In the case of a digital watch or a watch with a screen, the crown may also be used to navigate in menus provided by the watch, for example on the screen. Of course, the crown may be used for any mechanical adjustments as well.

The examples given in the present specification are only for illustrative purposes and should not be construed in a limiting manner. Other constructions are possible using equivalent means and within the spirit and scope of the present invention. The different embodiments and their technical features may be combined between them according to circumstances. Also, the present invention is not limited to an application in a watch but may be used in other devices.

1-9. (canceled)

10. A watch comprising:
a watch case; and
a watch base,
wherein the watch case and the watch base are configured to change the watch from an unsealed state to a sealed state and vice versa, the change between the unsealed state and the sealed state is made by a movement of the watch case relative to the watch base.

11. The watch of claim 10, wherein the movement is a rotation.

12. The watch of claim 10, wherein in the sealed state and in the unsealed state, the watch case and the watch base are in a same plane.

13. The watch of claim 10, wherein in the sealed state and in the unsealed state, the watch case and the watch base are not in a same plane.

14. The watch of claim 10, wherein the change to the sealed state includes a closing of the watch case with a crown.

15. The watch of claim 10, wherein the sealed state is a locked position of the watch case with respect to the watch base ensured by a locking device.

16. The watch of claim 10, further comprising:
a protection unit; and
a crown,
wherein the protection unit is configured to protect the crown.

17. The watch of claim 16, wherein the crown is configured to adjust an element of the watch.

18. The watch of claim 10, further comprising:
an hours pointer;
a minutes pointer; and
a seconds pointer,
wherein the minutes pointer forms a bridge under which the seconds pointer passes, the seconds pointer having a shape of a snail, such that a seconds value to be read is indicated on the minutes pointer.
